(19) United States
(12) Patent Application Publication
(10) Pub. No.: US 2025/0148356 A1
(43) Pub. Date: May 8, 2025

(54) AI-AIDED TOOLS INTEGRATION FOR DEVELOPMENT MODELS

(71) Applicant: SAP SE, Walldorf (DE)

(72) Inventor: Martin Weidner, Kronau (DE)

(73) Assignee: SAP SE, Walldorf (DE)

(21) Appl. No.: 18/503,962

(22) Filed: Nov. 7, 2023

(51) Int. Cl. G06N 20/00

(52) U.S. Cl. CPC G06N 20/00

(57) ABSTRACT

A data platform includes an artificial intelligence integration component (AIIC) to facilitate user interaction with the data platform, such as creation of a data pipeline to implement a desired use case. The AIIC manages interactions between the user and a chatbot which includes an artificial intelligence (AI) model. The AIIC also manages interactions between the user and technical internal components of the data platform such as a connectivity framework for establishing connections with source and target systems external to the data platform. The AI model is trained with language data and data regarding the data platform, such that the chatbot can participate in a dialog with the user of the data platform to formulate a problem statement associated with a desired use case. The AIIC connects with the technical internal components of the data platform to manage generation of a data pipeline based on the problem statement.

### FIELD

The field generally relates to facilitating user interaction with data platforms using dialog-based artificial intelligence (AI) tools.

### BACKGROUND

A growing degree of digitalization in industries worldwide increases the amount of generated data points from events, sensors, orders, and other data. The data is collected in different places, such as enterprise resource planning (ERP) systems, relational databases, object stores, document stores, and message queues. Data platforms aim to implement a value chain by integrating information from different source systems, e.g., using a data pipeline. However, the degree of complexity involved in exploiting the value chain is still high due to the need for specialized tooling, different programming and query languages, different paradigms to connect systems, and data privacy regulations (e.g., the European Union's General Data Protection Regulation (GDPR)). Accordingly, companies still require highly skilled and trained technical experts to successfully implement their use cases in data platforms. As such technical experts are in short supply and expensive, rapid progress in implementation projects is hindered.

### BRIEF DESCRIPTION OF THE DRAWINGS

FIG. 1 is a block diagram of an example system implementing an AI integration component in a data platform.

FIG. 2 is a block diagram of an example AI integration component.

FIG. 3 is a flowchart of an example method implementing an AI integration component in a data platform.

FIG. 4 is a block diagram of an example method implementing an AI integration component in a data platform to manage data pipeline creation.

FIG. 5 is a flowchart of an example method implementing an AI integration component to generate a graph representing a data pipeline.

FIGS. 6A and 6B are block diagrams of example graphs representing data pipelines.

FIG. 7 is a block diagram of an example system for generating predicted graphs representing data pipelines via a trained AI model.

FIG. 8 is a block diagram of an example computing system in which described embodiments can be implemented.

FIG. 9 is a block diagram of an example cloud computing environment that can be used in conjunction with the technologies described herein.

### DETAILED DESCRIPTION

### Example 1

### Overview

An AI integration component (AIIC) can be implemented in a data platform to assist users of the data platform with creation of data pipelines. A data pipeline can include a set of network connections and processing steps that moves data from a source connected system to a target connected system and transforms the data in accordance with a specified use case.

The AIIC can interface with a chatbot that incorporates an AI model. The AI model can be trained using information associated with the data platform, and can also incorporate a large language machine learning model (or simply “large language model”) so as to translate and respond to user input.

A large language model can take the form of an AI or machine learning model that is designed to understand and generate human language. Such models typically leverage deep learning techniques such as transformer-based architectures to process language with a very large number (e.g., billions) of parameters. Examples include the Generative Pre-trained Transformer (GPT) developed by OpenAI (e.g., ChatGPT), Bidirectional Encoder Representations from Transforms (BERT) by Google, A Robustly Optimized BERT Pretraining Approach developed by Facebook AI, Megatron-LM of NVIDIA, or the like. Pretrained models are available from a variety of sources.

By interfacing with the chatbot incorporating the AI model, the AIIC can guide the user to formulate their problem and supply details such as data sources, connection types, compliance regulations, encryption standards, data targets, and potential personally identifiable information in the data. Users can interact with the chatbot in a dialog form, either via text or speech, to solve problems. As used herein, the term “dialog” can represent a session, or technical transaction, which contains an interactive problem definition, solution finding, solution testing, and solution review/handover. In this context, a solution can include a data pipeline for implementing a productive use case of interest to the user.

The AIIC can also interact with technical internal components of the data platform during the dialog with the user. The technical internal components of the data platform can include a connectivity framework, a design-time environment for creating execution graphs representing data pipelines, and a runtime environment for testing the execution graphs.

Via the dialog, the user can trigger the lifecycle of a data pipeline definition, which is managed by the AIIC. Towards this end, the AIIC can create a graph description and instantiate new connectivity and configure existing connectivity between the data platform and systems external to the data platform (e.g., connected systems within another data platform). In addition, the AIIC can generate source/target system connectors (e.g., software components/modules that facilitate data flow between different systems), translate data transformation rules into graph source code, add to and/or modify the code using audit and debug logs, and ensure a secure configuration of the connectivity.

In examples where the AI model has learned insights about the connected systems, the AIIC can also recommend how to correlate, combine, or aggregate the data. Based on test runs or samples, the AIIC can provide back insights and sample results to the user to review the quality of the result. The AIIC can then forward the defined pipeline into the next phase of its lifecycle, such as review and activation.

The described technologies thus offer considerable improvements over conventional techniques for data pipeline creation. For example, the AIIC can reduce the degree of skill and training required for users of the data platform to implement use cases. Accordingly, a typical user of the data platform who does not have specialized training can be guided by the AIIC to formulate a problem statement and define a data pipeline. As a result, the need to delegate such tasks to technical experts (e.g., data scientists) can be reduced. The AIIC can also advantageously harness AI to automate repetitive tasks involved in creation of data pipelines.

Further, the AIIC can use AI to enable users to develop applications which consider regulatory requirements and security aspects, without requiring the users to have detailed knowledge of such regulations. Rather, the AI model is trained with this information.

While examples specific to data platforms are discussed herein, the disclosed techniques can also be applied to other types of software systems.

### Example 2

### Example System Implementing an AI Integration Component in a Data Platform

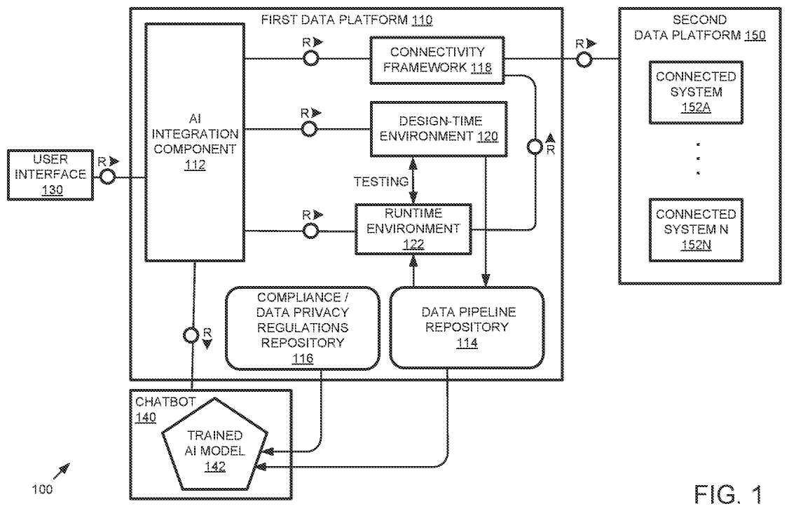

FIG. 1 is a block diagram of an example system 100 implementing an AIIC in a data platform. In the example, the system 100 includes a first data platform 110, a user interface 130, a chatbot 140, and a second data platform 150.

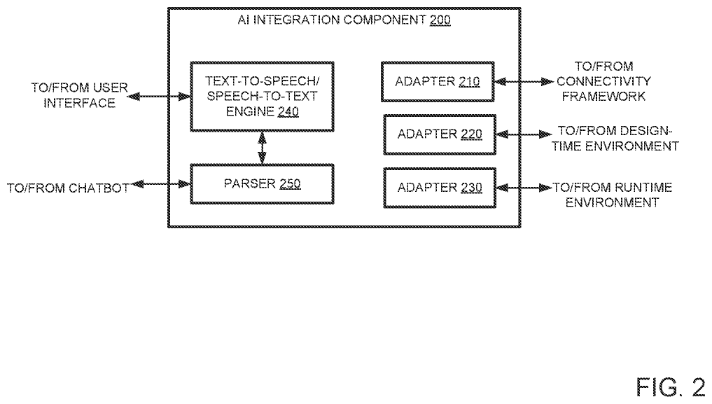

First data platform 110 comprises an AIIC 112. AIIC 112 serves as an interface between a user and the other components of first data platform 110, as well as between the user and chatbot 140. As discussed herein with reference to FIG. 2, AIIC 112 can include a plurality of adapters which enable communication with respective components within first data platform 110, as well as a text-to-speech/speech-to-text engine and a parser.

As described herein, chatbot 140 guides a user to formulate a problem and find a solution to the problem. In the example, the solution takes the form of a data pipeline; however, other types of solutions are also possible. In the example, chatbot 140 is depicted as being external to first data platform 110. In other examples, however, chatbot 140 can instead be part of first data platform 110.

Chatbot 140 comprises a trained AI model 142. AI model 142 can be trained as a large language model to enable chatbot 140 to translate and respond to user input. For example, the training data for AI model 142 can include data from the Internet, books, and public-accessible source code, among other data. In addition, the training data for AI model 142 can include data associated with first data platform 110, such as data stored in a data pipeline repository 114 for activated and reviewed data pipelines and data stored in a compliance/data privacy regulations repository 116.

Compliance/data privacy regulations repository 116 can include details regarding any compliance and/or data privacy regulations that are applicable to the data. For example, compliance/data privacy regulations repository 116 can include data which can be used to train AI model 142 to comply with regulations such as GDPR, as well as data which can be used to train AI model 142 to comply with compliance regulations for a specific customer of the data platform.

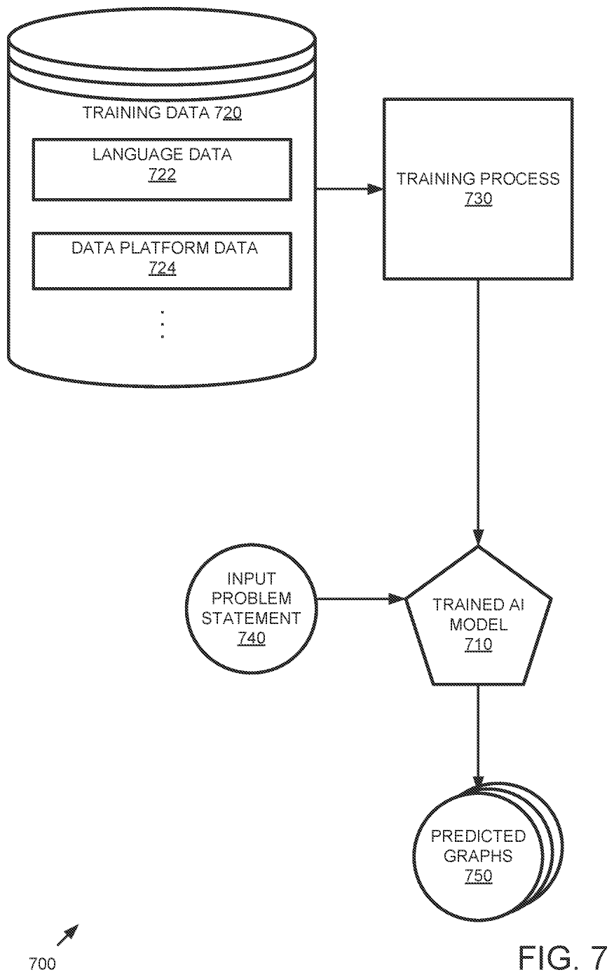

As discussed herein with reference to FIG. 7, additional training inputs to AI model 142 can include existing data graphs, potential connected system data, available connection types, and internally available Application Programming Interfaces (APIs). The training of AI model 142 can be an ongoing process, rather than a one-time process, such that the model is updated based on new information as it becomes available (e.g., new data privacy regulations or newly activated and reviewed data pipelines).

AIIC 112 also interfaces with a connectivity framework 118. Connectivity framework 118 can serve to express and configure connectivity between the first data platform 110 and one or more connected systems. Towards this end, connectivity framework 118 can include one or more drivers configured for connection with respective connected systems. As described herein, in some examples, AIIC 112 can facilitate the creation of new drivers at connectivity framework 118 for new connected systems or facilitate the specification and/or modification of existing drivers at connectivity framework 118 to support new configurations for existing connected systems. Further, connectivity framework 118 can specify connection types and definitions.

In the example, connectivity framework 118 serves as an interface between AIIC 112 and a plurality of connected systems 152A . . . 152N of second data platform 150. For a given data pipeline, each of the connected systems 152A . . . 152N can act as a source system (e.g., a source of data for the data pipeline) or a target system (e.g., a system to which data is moved via the data pipeline).

In the example, AIIC 112 also interfaces with a design-time environment 120 of first data platform 110. Design-time environment 120 is an environment for creation of execution graphs representing data pipelines. For example, for a given use case, the AIIC 112 can interface with design-time environment 120 to create an execution graph description, instantiate new connectivity and/or configure existing connectivity, and/or generate any needed source or target system connectors. The execution graphs created in design-time environment 120 can also include metadata discovery and sampling functionality. Further, the AIIC 112 can interface with design-time environment 120 to translate data transformation rules into graph source code, add to or modify the code using audit and debug logs, and/or ensure a secure configuration of the connectivity. In examples where the AI model 142 has learned insights regarding the connected systems, the AIIC can also recommend how to correlate, combine, or aggregate the data in design-time environment 120.

As shown, design-time environment 120 can interface with a runtime environment 122 of first data platform 110. The AIIC 112 can use runtime environment 122 to run test executions of the execution graphs generated in design-time environment 120. Based on the test executions, and/or based on samples obtained via the test executions, the AIIC 112 can return insights and sample results to the user via user interface 130 so that the user can review the quality of the results. During this testing period, the execution graph can be returned to the design-time environment 120 for modification until desired results are achieved.

Further, based on the sample results, the AI model 142 can be retrained or adapted to learn more about the structure of the data. The AI model 142 can then recommend adaptations to the current data pipeline so that it better conforms to the target scenario (e.g., with respect to performance, total cost of ownership, etc.).

As shown, runtime environment 122 communicates with connectivity framework 118. For example, in the process of running an execution graph, runtime environment 122 can interface with connectivity framework 118 in order to pull data from, and return data to, one or more of the connected systems 152A . . . 152N.

Once the execution graph produces satisfactory results, the AIIC 112 activates the associated data pipeline and stores it in the data pipeline repository 114 (which stores data pipelines that have been reviewed and activated). The data pipelines stored in data pipeline repository 114 can be implemented by a user upon request. Further, any new data pipelines added to data pipeline repository 114 can be forwarded as training inputs to AI model 142 for use in a subsequent training process of the model.

Any of the systems herein, including the system 100, can comprise at least one hardware processor and at least one memory coupled to the at least one hardware processor.

The system 100 can also comprise one or more non-transitory computer-readable media having stored therein computer-executable instructions that, when executed by the computing system, cause the computing system to perform any of the methods described herein.

In practice, the systems shown herein, such as system 100, can vary in complexity, with additional functionality, more complex components, and the like. For example, system 100 can include additional data platforms, and/or additional chatbots. First data platform 110 can include additional components which are not illustrated for the sake of brevity, and can connect to other data platforms in addition to second data platform 150.

The described computing systems can be networked via wired or wireless network connections, including the Internet. Alternatively, systems can be connected through an intranet connection (e.g., in a corporate environment, government environment, or the like).

The system 100 and any of the other systems described herein can be implemented in conjunction with any of the hardware components described herein, such as the computing systems described below (e.g., processing units, memory, and the like). In any of the examples herein, the AI model 142, the data pipeline repository 114, the compliance/data privacy regulations repository 116, the connectivity framework 118, and the like can include data stored in one or more computer-readable storage media or computer-readable storage devices. The technologies described herein can be generic to the specifics of operating systems or hardware and can be applied in any variety of environments to take advantage of the described features.

### Example 3

### Example AIIC

FIG. 2 is a block diagram of an example AIIC 200, which can be implemented in a data platform such as first data platform 110 of FIG. 1. In the example, AIIC 200 includes an adapter 210, an adapter 220, an adapter 230, a text-to-speech/speech-to-text (TTS/STT) engine 240, and a parser 250. AIIC 200 can optionally include other components which are not depicted in this example. For example, AIIC 200 can include one or more additional adapters for communicating with other components internal or external to the data platform.

Adapter 210 can be configured to communicate with a connectivity framework, such as connectivity framework 118 of FIG. 1. In particular, adapter 210 can communicate with a corresponding API endpoint of the connectivity framework. The communication can include the exchange of data, such as JavaScript Object Notation (JSON) data objects.

Adapter 220 can be configured to communicate with a design-time environment, such as design-time environment 120 of FIG. 1. In particular, adapter 220 can communicate with a corresponding API endpoint of the design-time environment. The communication can include the exchange of data, such as JSON data objects.

Adapter 230 can be configured to communicate with a runtime environment, such as runtime environment 122 of FIG. 1. In particular, adapter 230 can communicate with a corresponding API endpoint of the runtime environment. The communication can include the exchange of data, such as JSON data objects, execution status, or other metrics.

The parser 250 can be a software module configured to intermediate communications between a chatbot, such as chatbot 140 of FIG. 1, and a user. In particular, the parser 250 can receive input data, such as text, and break it down into smaller elements for translation or analysis. For example, during a dialog between the user and the AIIC 200, the AIIC 200 can instruct the chatbot to generate the next answer. Upon receipt of the answer generated by the chatbot at the AIIC 200, the parser 250 can determine an appropriate action to take. For example, the parser 250 can recognize whether to provide the answer back to the user, execute instructions (e.g., execute technical instructions such as instructions to create a connection in the connectivity framework or instructions to create or modify a graph for a data pipeline in the design-time environment), or extract samples from one or more connected systems.

TTS/STT engine 240 can be a software engine configured to receive text input and translate the text into speech, as well as to receive speech input and translate the speech into text. After engine 240 translates text (e.g., text received from parser 250 that originated at a chatbot) to speech, the speech can be output as audio to a user interface that includes a media output device, such as an audio speaker, as part of a dialog. Similarly, a user can provide spoken input to a user interface via a microphone or other capture device. The user interface can record the spoken input and transmit the recording to engine 240, which in turn can translate the speech in the recording to text. Alternatively, the spoken input can be transmitted to engine 240 for conversion to text in real time. The resulting text can form part of a dialog between the user and the AIIC 200. In some examples, the text generated by engine 240 from speech input by a user is transmitted to the parser 250 for processing prior to being transmitted to a chatbot.

In some examples, AIIC 200 does not include a TTS/STT engine 240, and instead conducts the dialog via text alone. In other examples, AIIC 200 includes engine 240 and the user is given a choice between a text-only dialog, a speech-only dialog, or a dialog including both text and speech.

### Example 4

### Example Method Implementing an AIIC in a Data Platform

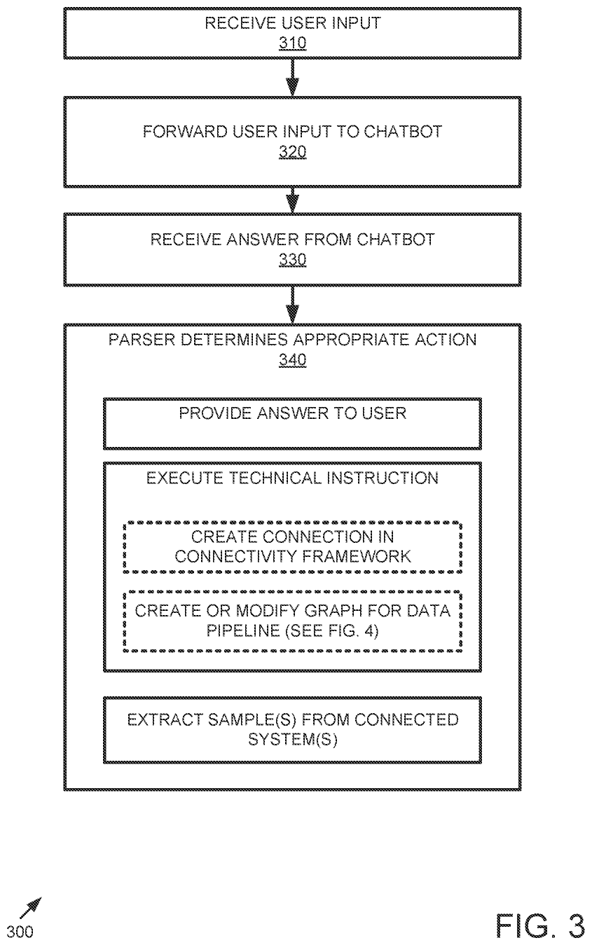

FIG. 3 is a flowchart of an example method 300 of implementing an AIIC in a data platform and can be performed, for example, by the system of FIG. 1. For example, method 300 can be performed by an AIIC of a data platform, such as AIIC 112 of FIG. 1, in conjunction with other components internal to and external to the data platform.

At 310, the method includes receiving user input. For example, the AIIC can begin a dialog with a user of the data platform using a chatbot, such as chatbot 140 of FIG. 1. In some examples, the user can initiate such a dialog by providing user input, e.g., in text or speech form, to a user interface of the data platform. In other examples, the AIIC can initiate the dialog by presenting a prompt to the user via a user interface, e.g., in text or speech form, and then receive user input in response to the prompt.

At 320, the AIIC forwards the user input to a chatbot (e.g., chatbot 140 of FIG. 1). In examples where the user input was received as speech, the AIIC can first transmit the user input to an engine, such as TTS/STT engine 240 of FIG. 2 to be converted to text. Optionally, the user input can be parsed by a parser, such as parser 250 of FIG. 2, before it is forwarded to the chatbot.

At 330, an answer is received from the chatbot, e.g., in text form. At 340, the parser of the AIIC analyzes the answer to determine an appropriate action. Example appropriate actions that can be determined by the parser include providing an answer to the user, such as to specify a reference system the pipeline should connect to, applicable data regulations that should be taken into account to automatically generate required data access logs, or problems identified due to mismatching data types.

The example appropriate actions determined by the parser can also include executing technical instructions. For example, the parser can determine, based at least in part on the answer received from the chatbot, that it is appropriate to create a connection in a connectivity framework of the data platform (e.g., connectivity framework 118 of FIG. 1). In this case, an adapter of the AIIC (e.g., adapter 210 of FIG. 2) can interface with the connectivity framework to create the connection. For example, the adapter can send a request to an API endpoint of the connectivity framework to create the desired connection.

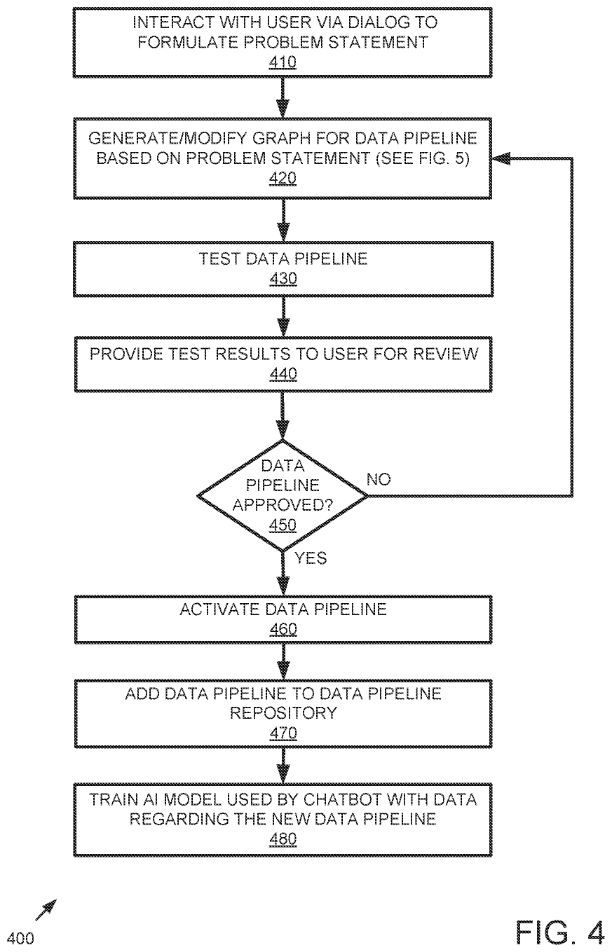

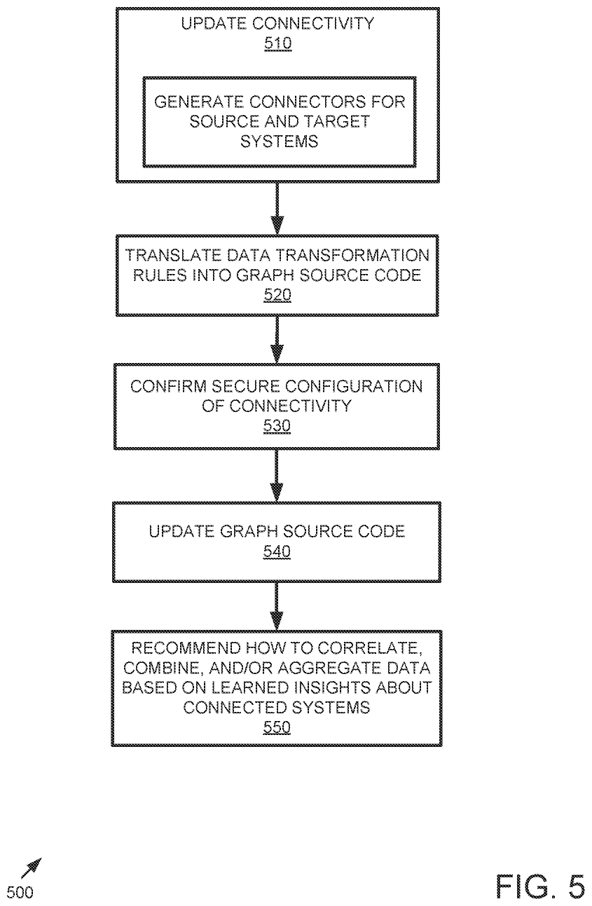

As another example of executing technical instructions in response to the answer received from the chatbot, the parser can determine based at least in part on the answer that it is appropriate to create or modify a graph for a data pipeline. In this case, the AIIC can guide the user, via a series of prompts, to supply pertinent information for creation/modification of the graph for the data pipeline, and then proceed to create the graph for the data pipeline by interfacing with a design-time environment of the data platform. The process of creating a graph for a data pipeline is described in further detail herein with reference to FIGS. 4 and 5.

The example appropriate actions determined by the parser can also include extracting one or more samples from one or more connected systems. For example, the parser can determine based at least in part on the answer that it is appropriate to extract one or more samples from one or more connected systems (e.g., one or more of connected systems 152A . . . 152N of FIG. 1). In this case, an adapter of the AIIC (e.g., adapter 210 of FIG. 2) can interface with the connectivity framework to establish connections with any systems from which samples are to be extracted, and then obtain the samples via the connections once they are established.

The method 300 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, receiving an answer can be described as sending an answer depending on perspective.

### Example 5

### Example Method Implementing an AIIC to Manage Data Pipeline Creation

FIG. 4 is a flowchart of an example method 400 implementing an AIIC in a data platform to manage data pipeline creation and can be performed, for example, by the system of FIG. 1. For example, method 400 can be performed by an AIIC of a data platform, such as AIIC 112 of FIG. 1, in conjunction with other components internal to and external to the data platform.

At 410, the AIIC interacts with a user of the data platform, via a dialog, to formulate a problem statement. The problem statement can be associated with a use case to be implemented by the data platform. Towards this end, the AIIC can interface with a chatbot, such as chatbot 140 of FIG. 1, to guide the user in formulating the problem statement via a series of prompts. The prompts, which can be presented to the user as text or speech, can include requests for the user to specify information regarding data that will be processed to produce a desired flow of data. A list of example prompts that can be presented to the user during formulation of the problem statement is provided in Table 1 below.

At 420, the AIIC manages generation or modification of a graph for a data pipeline based on the problem statement. The graph can be an execution graph, or another type of graph. The graph can be generated in a design-time environment of the data platform, such as design-time environment 120 of FIG. 1. The process for generating the graph, which is described in further detail herein with reference to FIG. 5, can include one or more of instantiating new connectivity, configuring existing connectivity, generating source and target system connectors, translating data transformation rules into graph source code, adding to/improving the graph source code using audit and debug logs, and ensuring that the configuration of the connectivity is secure.

In examples where the AI model has learned insights regarding one or more of the connected systems, the AIIC can also recommend how to correlate, combine, and/or aggregate the data at this stage. For example, the AI model may have learned insights regarding the connected systems based on previous interaction. That contextual knowledge can be accessed by the AIIC to facilitate management of graph generation for a data pipeline.

At 430, the AIIC tests the data pipeline associated with the graph generated at 420. The data pipeline can be tested in a runtime environment of the data platform, such as runtime environment 122 of FIG. 1. Testing the data pipeline in the runtime environment can include executing the graph.

At 440, the AIIC provides results of the test to the user for review. The results can include insights gleaned by the AIIC during the test and/or samples obtained from one or more connected systems during the test. In some examples, an AI review is also performed by the AIIC at this stage, e.g., using an AI model such as AI model 142 of FIG. 1.

At 450, the AIIC determines whether the user (and optionally, the AI review process) has approved the data pipeline associated with the graph. For example, after the test results have been presented to the user, the user can be prompted by the AIIC to provide a text or speech input indicating whether the data pipeline is approved. In response to receipt of an input from the user indicating that the data pipeline is not approved, the AIIC can optionally prompt the user to provide an explanation of why the data pipeline is not approved, or guide the user through a series of prompts to figure out what aspects of the data pipeline are unsatisfactory to the user. In examples where an AI review of the data pipeline has identified errors, the AIIC can present the errors to the user (e.g., via a user interface).

If the answer at 450 is NO, indicating that the user has not approved the data pipeline, the method returns to 420 to modify the graph associated with the data pipeline in the design-time environment. After modifying the draft graph, the AIIC can proceed to test the modified data pipeline in the runtime environment, provide the new test results to the user for review, and so on, until the data pipeline is approved by the user.

Otherwise, if the answer at 450 is YES, indicating that the user has approved the data pipeline, the method proceeds to 460 to activate the data pipeline. The activated data pipeline is then added to a data pipeline repository, such as data pipeline repository 114 of FIG. 1, at 470.

At 480, the AI model used by the chatbot is trained with data regarding the new data pipeline. This can include providing the execution graph for the new data pipeline as training data for the AI model.

### Example 6

### Example Dialog Prompts

During a dialog with the AIIC, a user of the data platform can formulate their problem statement in a natural way. From the problem statement, the AIIC guides the user to supply details using successive prompts. As an example, Table 1 below includes a list of example prompts that might be provided by the AIIC during a dialog.

TABLE 1
Dialog Prompts
Prompt

Which data from which source systems should
be selected?
Should the data be streamed or batched?
Can some selectors be pushed to the source systems
to reduce data transfer?
Are there missing connection types, so that a
generic connection type is instantiated and client
code is auto-generated?
Which data compliance regulations need to be considered?
Which data encryption standards must be
used for data in transit?
Which data authentication
methods are acceptable?
How should the source data be aggregated, combined,
and processed?
What are the data targets the data should be
forwarded to?
What compliance regulations are relevant for the
target systems? Do they match with the previously
defined requirements?
Is there any potential personal identifiable
information that is regulated and thus
needs special protection and audit logging?

### Example 7

### Example Method Implementing an AIIC to Generate a Graph Representing a Data Pipeline

FIG. 5 is a block diagram showing an example method 500 implementing an AIIC to generate a graph representing a data pipeline and can be performed, for example, by the system of FIG. 1. For example, method 500 can be performed by an AIIC of a data platform, such as AIIC 112 of FIG. 1, in conjunction with other components internal to and external to the data platform. In some examples, method 500 is performed at step 420 of method 400.

At 510, the AIIC updates connectivity, e.g., between the data platform and one or more connected systems. Updating the connectivity can include instantiating new connectivity and/or configuring existing connectivity, such as generating connectors for source and target systems.

At 520, the AIIC translates data transformation rules into graph source code. An AI model integrated with the AIIC, such as AI model 142 of FIG. 1, can assist with the translation. For example, the AI model can be executed to predict appropriate graph source code for data transformation rules that are input as part of a problem statement.

At 530, the AIIC confirms that the configuration of the connectivity is secure. For example, the AI model integrated with the AIIC can be trained with data regarding security policies applicable to the data. When executed, the AI model can predict appropriate security precautions for the data based on an input problem statement. For example, the AI model can check connection instances for enforced channel encryption or provide feedback on secure or insecure authentication methods.

At 540, the AIIC updates (e.g., adds to and/or modifies) the graph source code. Updating the graph source code can include, for example, making updates using audit and debug logs, or injecting code to call other security or compliance APIs to register information that may be relevant for cataloging or asset security.

At 550, the AIIC recommends how to correlate, combine, and/or aggregate data based on learned insights about the connected systems. The learned insights can refer to insights learned by the AI model integrated with the AIIC, e.g., based on observed data in its training dataset.

### Example 8

### Example Graphs

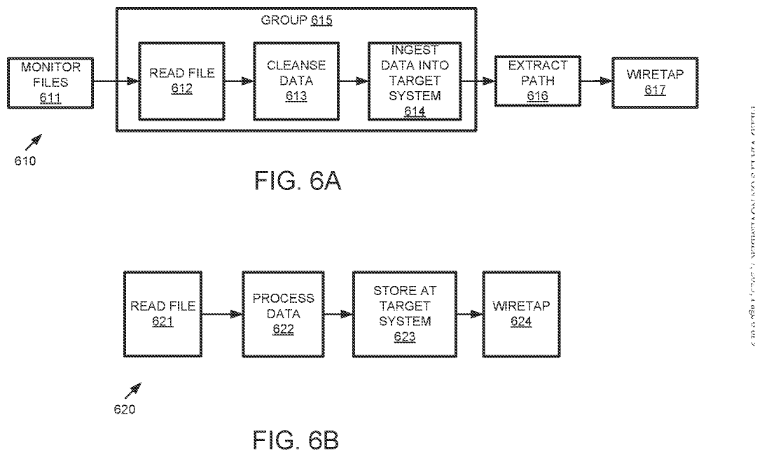

FIGS. 6A and 6B are block diagrams showing example graphs 610 and 620 for data pipelines and can be used in any of the examples herein. Management of graphs such as graphs 610 and 620 can be performed by an AIIC such as AIIC 112 of FIG. 1, in conjunction with an AI model such as AI model 142 of FIG. 1.

Turning first to FIG. 6A, it depicts a graph 610 which can be an execution graph for a data pipeline. In particular, graph 610 represents a data pipeline in which changes to files in a source system are stored in a target system. The source system and target system can each represent one of the connected systems 152A . . . 152N of FIG. 1 which are connected to first data platform 110 via connectivity framework 118.

Graph 610 includes a monitor files operator 611. Monitor files operator 611 can monitor files in the source system, and the data stored therein, for changes during execution of graph 610.

Graph 610 further includes a read file operator 612. During execution of graph 610, when a change to a file of the source system is detected, the file (or the changes thereto, alternatively referred to as “deltas”) can be loaded via read file operator 612. In some examples, multiple files and/or deltas can be read via read file operator 612 during a single execution of graph 610.

Graph 610 also includes a cleanse data operator 613. During execution of graph 610, the data in any files or deltas that were loaded via read files operator 612 can be cleansed via a cleanse data operator 613. The cleansing of the data can include, for example, cleansing of comma-separated value (CSV) columns within the data.

In addition, graph 610 includes an ingest data into target system operator 614. During execution of graph 610, after the data is cleansed, the data can be ingested into a target connected system via operator 614. In some examples, the target connected system is a Cloud computing database such as SAP Hana Cloud available from SAP SE of Walldorf, Germany.

In the example, operators 612, 613, and 614 form a group 615. In graphs such as graph 610, operators that are often used together in sequence can be grouped together to facilitate graph creation.

Graph 610 further includes an extract path operator 616 and a wiretap operator 617. During execution of graph 610, extract path operator 616 and wiretap operator 617 can be used to perform debugging. The debugging can include viewing which data are flowing through the pipeline, and viewing metrics associated with the data.

Turning next to FIG. 6B, it depicts a graph 620 which can be an execution graph for a data pipeline. In particular, graph 620 represents a data pipeline in which files are read and then stored in a target system.

Graph 620 includes a read file operator 621. During execution of graph 620, a file can be read via read file operator 621. In particular, the file can be read from a connected source system, such as one of connected systems 152A . . . 152N of FIG. 1, or from another source such as a database or event streaming platform. In some examples, multiple files can be read via read file operator 621 during a single execution of graph 620.

Graph 620 further includes a process data operator 622. During execution of graph 620, after the file is read via read file operator 621, the data therein can be processed via process data operator 622. The processing of the data can include, for example, processing, decoding, and/or transforming data tables within the data.

In addition, graph 620 includes a store at target system operator 623. During execution of graph 620, after the data is processed via process data operator 622, the processed data can be stored at a target system via store at target system operator 623. The target system can be a connected target system, such as one of connected systems 152A . . . 152N of FIG. 1. In some examples, the target connected system is a Cloud computing platform such as SAP Analytics Cloud available from SAP SE of Walldorf, Germany.

Graph 620 further includes a wiretap operator 624. During execution of graph 610, after the processed data is stored at the target system, wiretap operator 624 can be used to perform debugging. The debugging can include viewing which data are flowing through the pipeline, and viewing metrics associated with the data.

### Example 9

### Example System Training an AI Chatbot to Interface with an AIIC

FIG. 7 is a block diagram showing an example system 700 training an AI model 710 and can be used in any of the examples herein. In particular, AI model 710 can be trained with language data that enables a chatbot to conduct a natural dialog with a user. In addition, AI model 710 can be trained with data specific to a data platform. As described herein, AI model 710 can learn from the training data to make informed predictions regarding data pipeline graphs that will address an input problem statement.

Any of the systems herein, including the system 700, can comprise at least one hardware processor and at least one memory coupled to the at least one hardware processor.

In the example, the system 700 includes training data 720 for training the AI model 710. Training data 720 can include, among other data, language data 722 and data platform data 724, both of which are described further below.

The training data 720 is then used as an input to a training process 730. Training process 730 produces the trained AI model 710, which accepts an input problem statement 740 and generates one or more predicted graphs 750. The input problem statement can correspond to the problem statement formulated via method 400 using prompts such as those set forth in Table 1 above. The predicted graphs 750 generated by the model can be executed to implement a data pipeline. For example, the predicted graphs 750 can be executed in a runtime environment such as runtime environment 122 of FIG. 1.

The system 700 can also comprise one or more non-transitory computer-readable media having stored therein computer-executable instructions that, when executed by the computing system, cause the computing system to perform any of the methods described herein.

In practice, the systems shown herein, such as system 700, can vary in complexity, with additional functionality, more complex components, and the like. For example, the training data 720 can include significantly more training data and test data so that predictions can be validated. There can be additional functionality within the training process. Additional components can be included to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The system 700 and any of the other systems described herein can be implemented in conjunction with any of the hardware components described herein, such as the computing systems described below (e.g., processing units, memory, and the like). In any of the examples herein, the training data 720, trained AI model 710, and the like can be stored in one or more computer-readable storage media or computer-readable storage devices. The technologies described herein can be generic to the specifics of operating systems or hardware and can be applied in any variety of environments to take advantage of the described features.

### Example 10

### Example Training Data

In any of the examples herein, training data for an AI model can come from a variety of sources. The training data can include language data (e.g., language data 722 of FIG. 7), which can enable the language model to conduct a natural dialog with a user. For example, language data can include training data similar to that used for large language models, e.g., data scraped from the Internet, books, and other media sources.

The training data can also include data specific to a data platform (e.g., data platform data 724 of FIG. 7). For example, for a given data platform (e.g., first data platform 110 of FIG. 1), the training data specific to the data platform can include activated and reviewed pipelines data. The activated and reviewed pipelines data can include source code for graphs representing data pipelines which have already been reviewed and activated by the data platform.

The training data specific to the data platform can also include data regarding compliance and data privacy protection regulations. Training the AI model with such data can enable the model to identify and address issues with data compliance for a given data pipeline, as well as issues regarding data privacy protection regulations that are relevant to the data.

The training data specific to the data platform can also include observed (e.g., historical) data. The observed data can include metrics observed during runtime of a data pipeline, such as the quantity of data flowing through the data pipeline, the load on each operator or driver, the source and target connectivity, and/or whether performance is compromised during runtime of a data pipeline. The metrics can also include an estimate of the quantity of data flowing from the target system into the data pipeline or from the data pipeline back to the target system.

It will be appreciated that the training data for the trained AI model can include significantly more training data and test data so that predictions can be validated. There can also be additional functionality within the training process.

### Example 11

### Example Training Process

In any of the examples herein, training can proceed using a training process that trains the AI model using available training data. In practice, some of the data can be withheld as test data to be used during model validation.

Such a process typically involves feature selection and iterative application of the training data to a training process particular to the AI model. After training, the model can be validated with test data. An overall confidence score for the model can indicate how well the model is performing (e.g., whether it is generalizing well).

In practice, machine learning tasks and processes can be provided by machine learning functionality included in a platform in which the system operates. For example, in a database context, training data can be provided as input, and the embedded machine learning functionality can handle details regarding training.

### Example 12

### Example Integration into Software

In any of the examples herein, the technologies can be integrated into data management software. For example, SAP Data Intelligence or SAP HANA Data Management Suite, both available from SAP SE of Walldorf, Germany, can incorporate the features described herein to facilitate user creation of data pipelines.

### Example 13

### Example Implementations

Any of the following can be implemented.

Clause 1. A computer-implemented method comprising: training an AI model with training data comprising language data and data regarding a data platform; formulating a problem statement based on a dialog comprising communications from a chatbot comprising the AI model and inputs received at a user interface of the data platform; and generating a graph for a data pipeline based on the problem statement.

Clause 2. The method of Clause 1, wherein the dialog is managed by an AIIC configured to intermediate communications between the chatbot and the user interface.

Clause 3. The method of Clause 2, wherein: the AIIC manages the generating the graph; and the generating the graph comprises translating one or more data transformation rules into graph source code.

Clause 4. The method of Clause 3, wherein: the AIIC comprises an adapter configured to connect with a connectivity framework of the data platform; and the generating the graph further comprises updating connectivity between the data platform and one or more connected systems in the connectivity framework.

Clause 5. The method of Clause 4, wherein the one or more connected systems comprise at least one source system and at least one target system.

Clause 6. The method of any one of Clauses 4-5, wherein the generating the graph further comprises one or more of: confirming a secure configuration of the connectivity between the data platform and the one or more connected systems; and updating the graph source code using audit and debug logs.

Clause 7. The method of any one of Clauses 1-6, further comprising: executing the graph in a runtime environment of the data platform to test the data pipeline; and providing results of the test to the user interface.

Clause 8. The method of Clause 7, further comprising: receiving approval of the results of the test via the user interface; and responsive to the approval, activating the data pipeline and adding the activated data pipeline to a repository.

Clause 9. The method of Clause 8, further comprising: training the AI model using data regarding the activated data pipeline.

Clause 10. The method of any one of Clauses 1-9, further comprising: receiving an update to a compliance or data privacy regulation applicable to the data; and training the AI model based on the update.

Clause 11. A computing system comprising: at least one hardware processor; at least one memory coupled to the at least one hardware processor; and one or more non-transitory computer-readable media having stored therein computer-executable instructions that, when executed by the computing system, cause the computing system to perform: formulating a problem statement based on a dialog comprising communications from a chatbot and inputs received at a user interface of a data platform, the chatbot comprising a trained AI model; and generating a graph for a data pipeline based on the problem statement.

Clause 12. The system of Clause 11, further comprising an AIIC configured to manage communications between the user interface, the chatbot, and one or more technical internal components of the data platform.

Clause 13. The system of Clause 12, wherein the technical internal components of the data platform comprise a connectivity framework, a design-time environment, and a runtime environment.

Clause 14. The system of Clause 13, wherein the AIIC comprises a first adapter configured to connect to the connectivity framework, a second adapter configured to connect to the design-time environment, and a third adapter configured to connect to the runtime environment.

Clause 15. The system of any one of Clauses 13-14, wherein the AIIC is configured to manage the generating the graph, and wherein the generating the graph comprises translating one or more data transformation rules into graph source code in the design-time environment.

Clause 16. The system of Clause 15, wherein the generating the graph further comprises updating connectivity between the data platform and one or more connected systems in the connectivity framework.

Clause 17. The system of any one of Clauses 11-16, wherein training data for the AI model comprises language data and data regarding the data platform.

Clause 18. The system of any one of Clauses 14-17, wherein the AIIC further comprises a TTS/STT engine and a parser.

Clause 19. The system of Clause 18, wherein the parser is configured to: receive an answer from the chatbot; and determine, based on the answer, whether to convey the answer to the user interface, create a connection in the connectivity framework, modify the graph for the data pipeline, or extract one or more samples from a connected system.

Clause 20. One or more non-transitory computer-readable media comprising computer-executable instructions that, when executed by a computing system, cause the computing system to perform operations comprising: with a chatbot comprising a trained AI model, presenting a series of prompts to a user interface of a data platform to formulate a problem statement, the data platform comprising a connectivity framework and a design-time environment; and generating a graph for a data pipeline based on the problem statement, the generating the graph comprising: translating one or more data transformation rules into graph source code in the design-time environment; and updating connectivity between the data platform and one or more connected systems in the connectivity framework.

### Example 14

### Example Computing Systems

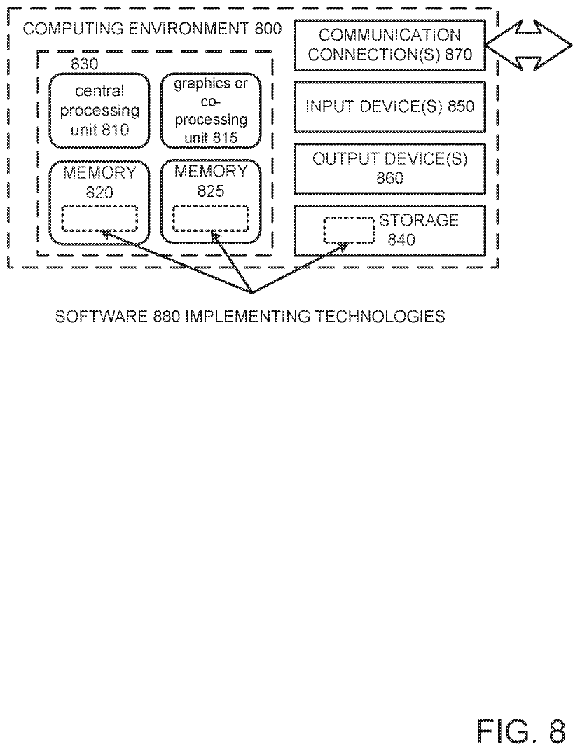

FIG. 8 depicts an example of a suitable computing system 800 in which the described innovations can be implemented. The computing system 800 is not intended to suggest any limitation as to scope of use or functionality of the present disclosure, as the innovations can be implemented in diverse computing systems.

With reference to FIG. 8, the computing system 800 includes one or more processing units 810, 815 and memory 820, 825. In FIG. 8, this basic configuration 830 is included within a dashed line. The processing units 810, 815 execute computer-executable instructions, such as for implementing the features described in the examples herein. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 8 shows a central processing unit 810 as well as a graphics processing unit or co-processing unit 815. The tangible memory 820, 825 can be volatile memory (e.g., registers, cache, RAM), non-volatile memory (e.g., ROM, EEPROM, flash memory, etc.), or some combination of the two, accessible by the processing unit(s) 810, 815. The memory 820, 825 stores software 880 implementing one or more innovations described herein, in the form of computer-executable instructions suitable for execution by the processing unit(s) 810, 815.

A computing system 800 can have additional features. For example, the computing system 800 includes storage 840, one or more input devices 850, one or more output devices 860, and one or more communication connections 870, including input devices, output devices, and communication connections for interacting with a user. An interconnection mechanism (not shown) such as a bus, controller, or network interconnects the components of the computing system 800. Typically, operating system software (not shown) provides an operating environment for other software executing in the computing system 800, and coordinates activities of the components of the computing system 800.

The tangible storage 840 can be removable or non-removable, and includes magnetic disks, magnetic tapes or cassettes, CD-ROMs, DVDs, or any other medium which can be used to store information in a non-transitory way and which can be accessed within the computing system 800. The storage 840 stores instructions for the software 880 implementing one or more innovations described herein.

The input device(s) 850 can be an input device such as a keyboard, mouse, pen, or trackball, a voice input device, a scanning device, touch device (e.g., touchpad, display, or the like) or another device that provides input to the computing system 800. The output device(s) 860 can be a display, printer, speaker, CD-writer, or another device that provides output from the computing system 800.

The communication connection(s) 870 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Example 15

### Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing system to perform the method. The technologies described herein can be implemented in a variety of programming languages.

### Example 16

### Example Cloud Computing Environment

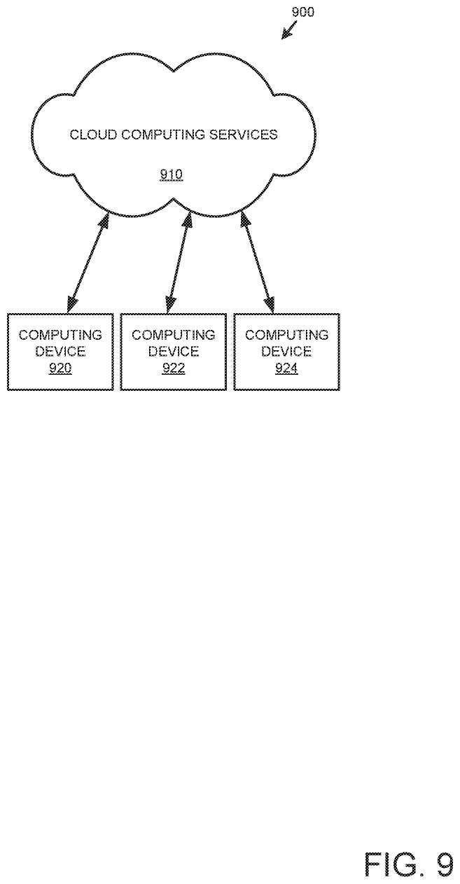

FIG. 9 depicts an example cloud computing environment 900 in which the described technologies can be implemented, including, e.g., the system 100 of FIG. 1 and other systems herein. The cloud computing environment 900 comprises cloud computing services 910. The cloud computing services 910 can comprise various types of cloud computing resources, such as computer servers, data storage repositories, networking resources, etc. The cloud computing services 910 can be centrally located (e.g., provided by a data center of an enterprise or organization) or distributed (e.g., provided by various computing resources located at different locations, such as different data centers and/or located in different cities or countries).

The cloud computing services 910 are utilized by various types of computing devices (e.g., client computing devices), such as computing devices 920, 922, and 924. For example, the computing devices (e.g., 920, 922, and 924) can be computers (e.g., desktop or laptop computers), mobile devices (e.g., tablet computers or smart phones), or other types of computing devices. For example, the computing devices (e.g., 920, 922, and 924) can utilize the cloud computing services 910 to perform computing operations (e.g., data processing, data storage, and the like).

In practice, cloud-based, on-premises-based, or hybrid scenarios can be supported.

### Example 17

### Example Implementations

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

### Example 18

### Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method comprising:
training an artificial intelligence (AI) model with training data comprising language data and data regarding a data platform;
formulating a problem statement based on a dialog comprising communications from a chatbot comprising the AI model and inputs received at a user interface of the data platform; and
generating a graph for a data pipeline based on the problem statement.

2. The method of claim 1, wherein the dialog is managed by an AI integration component (AIIC) configured to intermediate communications between the chatbot and the user interface.

3. The method of claim 2, wherein:
the AIIC manages the generating the graph; and
the generating the graph comprises translating one or more data transformation rules into graph source code.

4. The method of claim 3, wherein:
the AIIC comprises an adapter configured to connect with a connectivity framework of the data platform; and
the generating the graph further comprises updating connectivity between the data platform and one or more connected systems in the connectivity framework.

5. The method of claim 4, wherein the one or more connected systems comprise at least one source system and at least one target system.

6. The method of claim 4, wherein the generating the graph further comprises one or more of:
confirming a secure configuration of the connectivity between the data platform and the one or more connected systems; and
updating the graph source code using audit and debug logs.

7. The method of claim 1, further comprising:
executing the graph in a runtime environment of the data platform to test the data pipeline; and
providing results of the test to the user interface.

8. The method of claim 7, further comprising:
receiving approval of the results of the test via the user interface; and
responsive to the approval, activating the data pipeline and adding the activated data pipeline to a repository.

9. The method of claim 8, further comprising:
training the AI model using data regarding the activated data pipeline.

10. The method of claim 1, further comprising:
receiving an update to a compliance or data privacy regulation applicable to the data; and
training the AI model based on the update.

11. A computing system comprising:
at least one hardware processor;
at least one memory coupled to the at least one hardware processor; and
one or more non-transitory computer-readable media having stored therein computer-executable instructions that, when executed by the computing system, cause the computing system to perform:
formulating a problem statement based on a dialog comprising communications from a chatbot and inputs received at a user interface of a data platform, the chatbot comprising a trained artificial intelligence (AI) model; and
generating a graph for a data pipeline based on the problem statement.

12. The system of claim 11, further comprising an AI integration component (AIIC) configured to manage communications between the user interface, the chatbot, and one or more technical internal components of the data platform.

13. The system of claim 12, wherein the technical internal components of the data platform comprise a connectivity framework, a design-time environment, and a runtime environment.

14. The system of claim 13, wherein the AIIC comprises a first adapter configured to connect to the connectivity framework, a second adapter configured to connect to the design-time environment, and a third adapter configured to connect to the runtime environment.

15. The system of claim 13, wherein the AIIC is configured to manage the generating the graph, and wherein the generating the graph comprises translating one or more data transformation rules into graph source code in the design-time environment.

16. The system of claim 15, wherein the generating the graph further comprises updating connectivity between the data platform and one or more connected systems in the connectivity framework.

17. The system of claim 11, wherein training data for the AI model comprises language data and data regarding the data platform.

18. The system of claim 14, wherein the AIIC further comprises a TTS/STT engine and a parser.

19. The system of claim 18, wherein the parser is configured to:
receive an answer from the chatbot; and
determine, based on the answer, whether to convey the answer to the user interface, create a connection in the connectivity framework, modify the graph for the data pipeline, or extract one or more samples from a connected system.

20. One or more non-transitory computer-readable media comprising computer-executable instructions that, when executed by a computing system, cause the computing system to perform operations comprising:
with a chatbot comprising a trained artificial intelligence (AI) model, presenting a series of prompts to a user interface of a data platform to formulate a problem statement, the data platform comprising a connectivity framework and a design-time environment; and
generating a graph for a data pipeline based on the problem statement, the generating the graph comprising:
translating one or more data transformation rules into graph source code in the design-time environment; and
updating connectivity between the data platform and one or more connected systems in the connectivity framework.
